(19) United States
(12) Patent Application Publication
(10) Pub. No.: US 2009/0006669 A1
(43) Pub. Date: Jan. 1, 2009

(54) DMA TRANSFER CONTROL DEVICE AND METHOD OF DMA TRANSFER

(75) Inventors: Keiichi Toyama, Kanagawa (JP); Weiyu Wu, Kanagawa (JP); Yukiya Sakuma, Kanagawa (JP); Katsumi Watanabe, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kanagawa (JP)

(21) Appl. No.: 12/146,102

(22) Filed: Jun. 25, 2008

(30) Foreign Application Priority Data
Jun. 26, 2007 (JP) 2007-167265

(51) Int. Cl. G06F 13/28

(52) U.S. Cl. 710/35

(57) ABSTRACT

A DMA transfer control device for controlling a DMA transfer between a source and a destination is provided. The DMA transfer control device has: a buffer in which a transfer data is stored; and a bus cycle generation unit performing a burst transfer of the transfer data between the buffer and the source or the destination. The bus cycle generation unit performs an undefined-length burst transfer until an access address reaches a burst address boundary in the source or the destination. The bus cycle generation unit performs a fixed-length burst transfer after the undefined-length burst transfer until transfer of the transfer data is completed.

### INCORPORATION BY REFERENCE

This application is based upon and claims the benefit of priority from Japanese patent application No. 2007-167265, filed on Jun. 26, 2007, the disclosure of which is incorporated herein in its entirely by reference.

### BACKGROUND OF THE INVENTION

1. Field of the Invention

The present invention relates to a DMA transfer technique. In particular, the present invention relates to a technique of controlling a DMA transfer that uses a burst transfer.

2. Description of Related Art

A high-speed memory such as an SDRAM (Synchronous Dynamic Random Access Memory) is equipped with a burst mode that performs a “burst transfer”, in order to achieve a high-speed data transfer. In the burst transfer, a starting address of consecutive addresses is specified and then data reading or data writing are sequentially executed from the starting address (refer to Japanese Laid-Open Patent Application JP-2005-141682, for example).

Moreover, a “DMA (Direct Memory Access) transfer” is known as a technique for reducing CPU load at the time of the data transfer (refer to Japanese Laid-Open Patent Application JP-2006-18642, for example). In the DMA transfer, data is directly transferred to a memory without through processing by the CPU. For this reason, a DMA transfer control device is provided between a source and a destination of the data transfer. The DMA transfer control device performs the DMA transfer between the transfer source and the transfer destination in response to an instruction from the CPU. At the time of the DMA transfer, the above-mentioned burst transfer is often used.

In recent years, a high-performance and high-speed CPU enables a streaming technology that utilizes network communication. When processing large volume contents by the streaming, it is desirable not only to speed up the data transfer but also to reduce the CPU load. Therefore, the DMA transfer technique using the burst transfer is important.

There is the following problem with regard to the burst transfer. For example, let us consider a case of an SDRAM that has a plurality of pages. One page is a memory area of a predetermined size such as 512 bytes, 1 Kbytes or 2 Kbytes. Here, there may be a case where memory accesses during the burst transfer are not completed within the same page but extend over plural pages. However, a burst transfer that crosses (strides across) a page boundary between two pages is not permitted in the SDRAM. It is therefore necessary to once terminate the burst transfer at the page boundary and to initiate a new burst transfer after giving a new starting address of a new page. This deteriorates the data transfer efficiency, which is the problem.

Japanese Laid-Open Patent Application JP-2006-18642 discloses a DMA transfer control device designed to efficiently perform the burst transfer that crosses a page boundary. FIG. 1 shows a configuration of the DMA transfer control device 200. The DMA transfer control device 200 is provided with a source address register 201, a destination address register 202, a transfer size register 203, a buffer size comparison unit 204, a page boundary determination unit 205, an unprocessed transfer determination unit 206, a buffer 208, a bus cycle generation unit 209 and a DMA transfer controller 210. The DMA transfer control device 200 is connected to a CPU 100, a transfer source memory 211 and a transfer destination memory 212 through an external bus.

The operation at the time of a DMA transfer from the transfer source memory 211 to the transfer destination memory 212 is as follows. Note that a source address, a destination address and a transfer size are respectively set in the source address register 201, the destination address register 202 and the transfer size register 203 by the CPU 100.

The DMA transfer controller 210 judges whether or not a DMA transfer request is input through an external interface. When the DMA transfer controller 210 receives the DMA transfer request, the CPU 100 instructs the DMA transfer controller 210 to initiate the DMA transfer. The DMA transfer controller 210 instructs the DMA transfer control device 200 to execute the DMA transfer.

First, the buffer size comparison unit 204 reads the “transfer size” indicating the whole data transfer amount from the transfer size register 203. Then, the buffer size comparison unit 204 compares the transfer size with a buffer size that is a capacity of the buffer 208, to set a “processing transfer size”. The processing transfer size is a data amount to be transferred in a base transfer unit (the base transfer unit is referred to as a “period” hereinafter), and the maximum value of the processing transfer size is the buffer size. If the transfer size is larger than the buffer size, the processing transfer size is set to the buffer size. On the other hand, if the transfer size is equal to or smaller than the buffer size, the processing transfer size is set to the transfer size. FIG. 2 shows one example of the various sizes. In the example shown in FIG. 2, the transfer size is larger than the buffer size. Therefore, the processing transfer size in the first period is set to the buffer size.

Next, the page boundary determination unit 205 reads the source address from the source address register 201 and receives the processing transfer size from the buffer size comparison unit 204. Then, the page boundary determination unit 205 determines whether or not data reading crosses a page boundary in the transfer source memory 211, based on the source address, the processing transfer size and a page size of the transfer source memory 211. In the example shown in FIG. 2, the data reading in the first period crosses a page boundary. In this case, the page boundary determination unit 205 divides the processing transfer size at the page boundary in order to achieve the data reading in a divisional manner, and calculates a “divided transfer size”.

In a first data reading in the first period, the divided transfer size is a size from the source address to the page boundary. The bus cycle generation unit 209 reads data of the divided transfer size from the source address of the transfer source memory 211, and stores the read data in the buffer 208. The unprocessed transfer determination unit 206 detects that a part of the data of the processing transfer size is not yet transferred, and calculates a next divided transfer size. In a second data reading in the first period, the bus cycle generation unit 209 reads the remaining data following the page boundary in the transfer source memory 211, and stores the read data in the buffer 208. It should be noted that the data transfer from the transfer source memory 211 to the buffer 208 is performed based on the burst transfer in accordance with a data bus width.

Next, data writing in the first period is performed. More specifically, the destination address is read from the destination address register 202, and the data stored in the buffer 208 are written to the transfer destination memory 212 sequentially from the destination address thereof. At this time, as in the case of the data reading, the page boundary determination unit 205 determines whether or not the data writing crosses a page boundary in the transfer destination memory 212, based on the destination address, the processing transfer size and a page size of the transfer destination memory 212. If necessary, the processing transfer size is divided at the page boundary and a divided transfer size is calculated. The bus cycle generation unit 209 reads data of the divided transfer size from the buffer 208, and writes the read data to the transfer destination memory 212. It should be noted that the data transfer from the buffer 208 to the transfer destination memory 212 is performed based on the burst transfer in accordance with the data bus width.

When one period is finished, whether or not unprocessed transfer data remains in the transfer source memory 211 is determined. When unprocessed transfer data remains, a size of the unprocessed transfer data is set as a new transfer size. In the example shown in FIG. 2, a difference between the original transfer size and the processing transfer size (buffer size) transferred in the foregoing first period is set as the transfer size in the second period. Moreover, the source address and the destination address are updated. Then, the data transfer in the second period is performed as in the first period. The same processing is repeated until the remaining transfer size becomes zero.

Regarding the example shown in FIG. 2, let us consider a case where the transfer size is 260 bytes, the buffer size is 256 bytes and the data bus width is 16 bytes. In this case, the processing transfer size in the first period is 256 bytes. Therefore, the data transfer processing based on the burst transfer is performed at least for 16 times in the first period. The processing transfer size in the second period is the remaining 4 bytes, and thus the data transfer processing is performed once.

In this manner, the DMA transfer control device 200 performs the DMA transfer based on the burst transfer. Since the processing transfer data is divided at a page boundary, the burst transfer that crosses the page boundary becomes possible.

The inventors of the present application have recognized the following points. According to the technique shown in FIG. 1 and FIG. 2, the burst transfer operation is sectioned at every page boundary. Therefore, an undefined-length burst transfer occurs at every page boundary. Since overheads such as judgment of at-end condition and the like are necessary for the undefined-length burst transfer, the data transfer time becomes longer as compared with a fixed-length burst transfer. In a case where large volume data need to be transferred (e.g. the streaming in the network communication), the number of page boundary crossing times during the data transfer is increased. The undefined-length burst transfer and its overhead increase in proportion to the number of times. Therefore, the data transfer efficiency is deteriorated as the size of the transfer data is increased.

### SUMMARY

According to the present invention, a technique of a DMA transfer of a transfer data between a source and a destination is provided. A memory as the transfer source or the transfer destination is accessed by a DMA transfer control device based on the burst transfer. One page in the memory is accessed by plural burst transfers and includes a plurality of burst address boundaries. Here, the burst address boundaries are a plurality of boundaries obtained by sectioning the page by a fixed-length burst size from the last address of the page (i.e. a page boundary of the page) towards the smaller address direction. Therefore, one of the burst address boundaries matches the page boundary. This feature is utilized in the present invention.

More specifically, an “undefined-length burst transfer” is performed from an arbitrary access address to a burst address boundary. Once an access address reaches the burst address boundary, a “fixed-length burst transfer” is repeated thereafter. Since a page boundary matches a burst address boundary, it is possible to repeat the fixed-length burst transfer until the whole transfer data is transferred, without paying attention to the page boundaries.

In one embodiment of the present invention, a DMA transfer control device for controlling a DMA transfer between a source and a destination is provided. The DMA transfer control device comprises: a buffer in which a transfer data is stored; and a bus cycle generation unit configured to perform a burst transfer of the transfer data between the buffer and the source or destination. The bus cycle generation unit performs an undefined-length burst transfer until an access address reaches a burst address boundary in the source or destination. Moreover, the bus cycle generation unit performs a fixed-length burst transfer after the undefined-length burst transfer until transfer of the transfer data is completed.

In another embodiment of the present invention, a method of DMA transfer of a transfer data between a source and a destination is provided. The method includes: performing an undefined-length burst transfer of the transfer data until an access address reaches a burst address boundary in the source or destination; and performing a fixed-length burst transfer of the transfer data after the undefined-length burst transfer until transfer of the transfer data is completed.

According to the configuration or the method described above, it is possible to repeat the fixed-length burst transfer without paying attention to the page boundaries. Special processing such as interrupting a burst transfer operation is not necessary at a page boundary. Moreover, the undefined-length burst transfer that is accompanied by the overheads needs not be performed at every page boundary. Therefore, the overheads at every page boundary are eliminated and thereby the deterioration of the data transfer efficiency can be prevented. Even in a case where large volume data need to be transferred and hence a large number of page boundary crossings occur during the data transfer, the data transfer efficiency can be maintained.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a configuration of a DMA transfer control device according to a related technique;

FIG. 2 is a conceptual diagram for explaining an operation of the DMA transfer control device shown in FIG. 1;

FIG. 3 is a block diagram showing a configuration of a data processing equipment according to a first embodiment of the present invention;

FIG. 4 is a flowchart showing an operation of a DMA transfer control device according to the first embodiment;

FIG. 5 is a timing chart showing one example of the operation of the DMA transfer control device according to the first embodiment;

FIG. 6 is a block diagram showing a configuration of a data processing equipment according to a second embodiment of the present invention;

FIG. 7 is a flowchart showing an operation of the DMA transfer control device according to the second embodiment;

FIG. 8 is a block diagram showing a configuration of a data processing equipment according to a third embodiment of the present invention; and

FIG. 9 is a flowchart showing an operation of the DMA transfer control device according to the third embodiment.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### 1. First Embodiment

### 1-1. Configuration

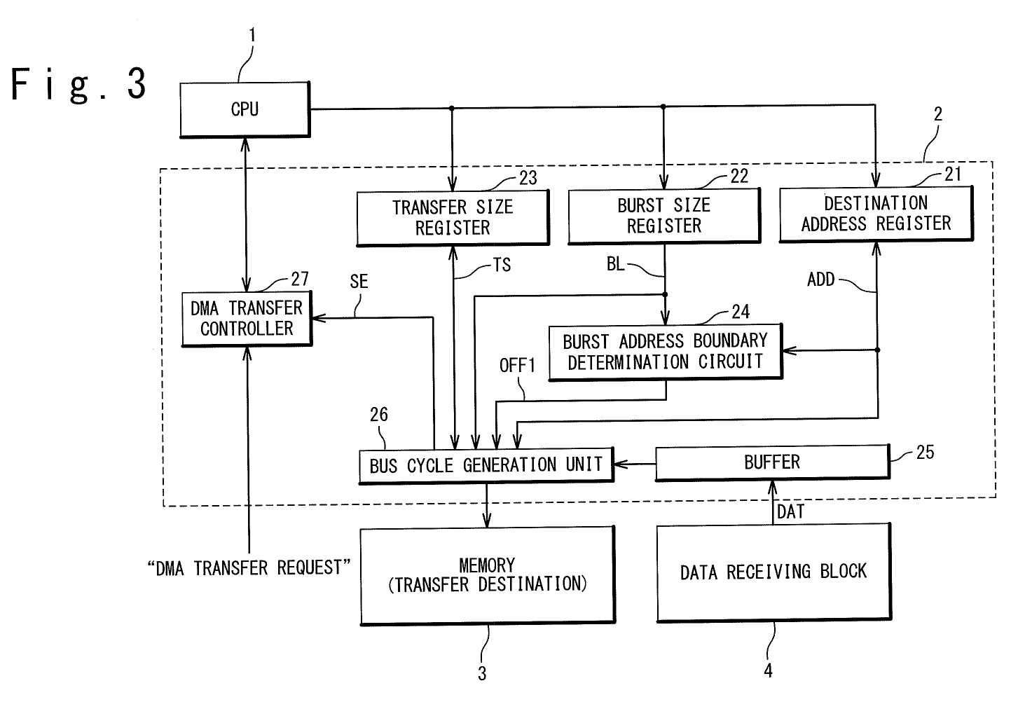

FIG. 3 is a block diagram showing a configuration of a data processing equipment according to a first embodiment of the present invention. The data processing equipment is provided with a CPU 1, a DMA transfer control device 2, a memory 3 and a data receiving block 4. The CPU 1, the DMA transfer control device 2, the memory 3 and the data receiving block 4 are connected to each other through a bus.

The memory 3 is, for example, an SDRAM that supports the burst mode and has a plurality of pages. One page is a memory area of a predetermined size such as 512 bytes, 1 Kbytes or 2 Kbytes. One page in the memory 3 is accessed by plural burst transfers and includes a plurality of burst address boundaries. In the present embodiment, a DMA transfer to the memory 3 will be described. That is to say, the memory 3 is a “transfer destination” of the data transfer.

On the other hand, the data receiving block 4 is a “transfer source” of the data transfer. For example, the data receiving block 4 extracts transfer data DAT such as packet data and streaming data from communication data in network communication. The transfer data DAT is the data to be transferred to the memory 3. The data receiving block 4 outputs the transfer data DAT to the DMA transfer control device 2.

The DMA transfer control device 2 performs and controls the DMA transfer of the transfer data DAT from the data receiving block 4 (transfer source) to the memory 3 (transfer destination). At the time of the DMA transfer, the DMA transfer control device 2 performs writing of the transfer data DAT to the memory 3 by using the burst transfer. As shown in FIG. 3, the DMA transfer control device 2 according to the present embodiment includes a destination address register 21, a burst size register 22, a transfer size register 23, a burst address boundary determination circuit 24, a buffer 25, a bus cycle generation unit 26 and a DMA transfer controller 27.

The destination address register 21 holds a “destination address ADD.” The destination address ADD is an access address in the memory 3 that is accessed at the time of the DMA transfer. Prior to the DMA transfer, the destination address ADD is set to an access start address by the CPU 1.

The burst size register 22 holds a “burst size (burst length) BL” with regard to one fixed-length burst transfer. For example, the burst size BL is “4”. When one word is 32 bits and the data bus width is 4 bytes, a data of 16 bytes is transferred by one fixed-length burst transfer. Prior to the DMA transfer, the burst size BL is set by the CPU 1.

The transfer size register 23 holds a “transfer size TS”. The transfer size TS is a size of the transfer data DAT that is scheduled to be DMA-transferred. Prior to the DMA transfer, the transfer size TS is set to the size of the transfer data DAT.

The burst address boundary determination circuit 24 reads the destination address ADD from the destination address register 21 and reads the burst size BL from the burst size register 22. Based on the destination address ADD and the burst size BL, the burst address boundary determination circuit 24 calculates a “burst offset value OFF1” that is an offset from the destination address ADD to a burst address boundary that comes first after the destination address ADD.

Here, burst address boundaries in a page of the memory 3 are a plurality of boundaries obtained by sectioning the page by the fixed-length burst size BL from the last address of the page (i.e. a page boundary of the page) towards the smaller address direction. The burst size BL is an aliquot of the size of the page. For example, one page consists of 512 words and the burst size BL is 4 words (16 bytes). Since the burst size BL (one fixed-length burst transfer size) is smaller than the page size, one page includes the plurality of burst address boundaries. One of the burst address boundaries matches a page boundary of the page.

It can be said that the burst offset value OFF1 is a size from the destination address ADD to a fixed-length burst address that comes first after the destination address ADD. For example, the burst address boundary determination circuit 24 can calculate the burst offset value OFF1 by comparing lower bits of the destination address ADD with the burst address boundary. As described above, the burst address boundary determination circuit 24 functions as an “offset calculation circuit” that calculates the burst offset value OFF1.

The buffer 25 holds the transfer data DAT received from the data receiving block 4 through the data bus. The transfer data DAT stored in the buffer 25 is burst-transferred to the memory 3 through the bus cycle generation unit 26.

The bus cycle generation unit 26 is connected to the buffer 25 and the bus, and performs the burst transfer of the transfer data DAT between the buffer 25 and the memory 3. More specifically, the bus cycle generation unit 26 reads the destination address ADD from the destination address register 21 and reads the burst size BL from the burst size register 22. Furthermore, the bus cycle generation unit 26 receives the burst offset value OFF1 from the burst address boundary determination circuit 24. The bus cycle generation unit 26 first performs an “undefined-length burst transfer” for the burst offset value OFF1 from the destination address ADD (start address), and thereafter performs the “fixed-length burst transfer” until the DMA transfer of the transfer data DAT is completed. For this reason, the bus cycle generation unit 26 includes both of a circuit for performing the undefined-length burst transfer and a circuit for performing the fixed-length burst transfer. It should be noted that if the burst offset value OFF1 is equal to zero, the bus cycle generation unit 26 performs only the fixed-length burst transfer.

Moreover, the bus cycle generation unit 26 reads the transfer size TS from the transfer size register 23. The bus cycle generation unit 26 can detect completion of the DMA transfer by comparing the amount of transfer data DAT already written to the memory 3 with the transfer size TS. When the DMA transfer of the whole transfer data DAT is completed, the bus cycle generation unit 26 outputs a transfer completion signal SE to the DMA transfer controller 27.

The DMA transfer controller 27 is a circuit for controlling the DMA transfer. More specifically, the DMA transfer controller 27 instructs the DMA transfer control device 2 to initiate the DMA transfer, in response to an instruction from the CPU 1. Moreover, the DMA transfer controller 27 notifies the CPU 1 of the completion of the DMA transfer, in response to the transfer completion signal SE received from the bus cycle generation unit 26.

### 1-2. Operation

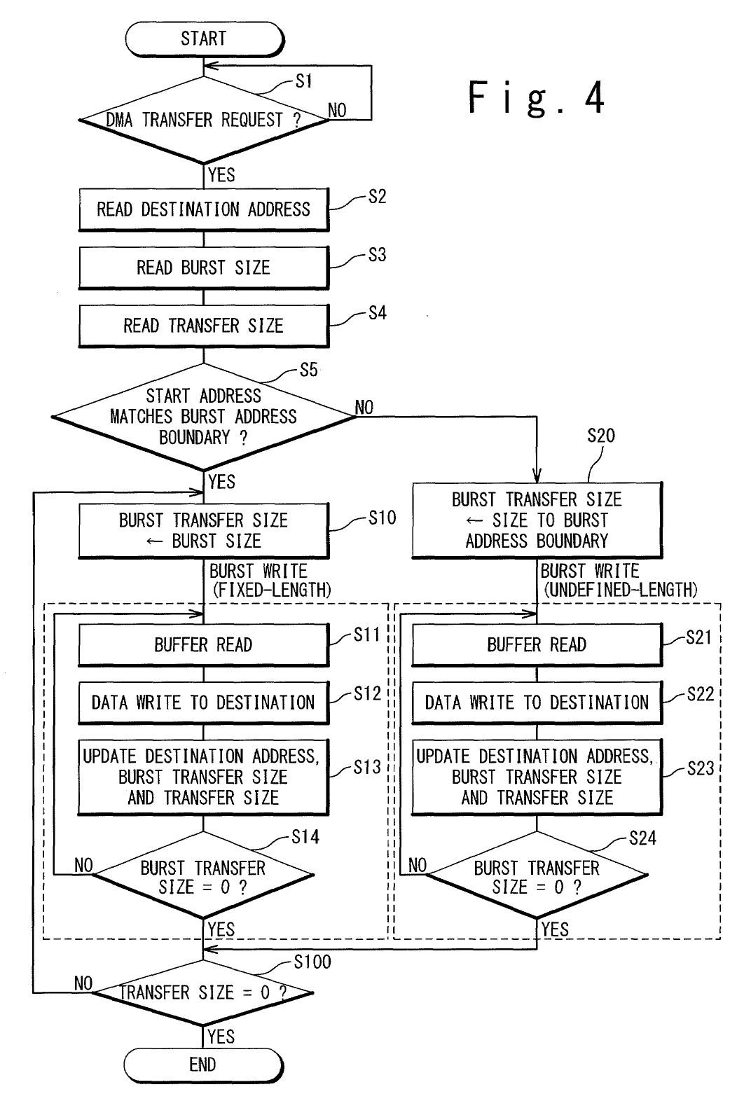

FIG. 4 is a flowchart showing an operation of the DMA transfer control device 2 according to the present embodiment. The DMA transfer according to the present embodiment will be described below with reference to FIGS. 3 and 4.

The destination address ADD (start address), the burst size BL and the transfer size TS are respectively set in the destination address register 21, the burst size register 22 and the transfer size register 23 by the CPU 1 in advance. First, the DMA transfer controller 27 judges whether or not a DMA transfer request is input through an external interface (Step S1).

When the DMA transfer controller 27 receives the DMA transfer request (Step S1; Yes), the burst address boundary determination circuit 24 and the bus cycle generation unit 26 read the destination address ADD (start address) from the destination address register 21 (Step S2) and read the burst size BL from the burst size register 22 (Step S3). Moreover, the bus cycle generation unit 26 reads the transfer size TS from the transfer size register 23 (Step S4).

Based on the start address ADD and the burst size BL, the burst address boundary determination circuit 24 calculates the burst offset value OFF1 that is an offset from the start address ADD to a burst address boundary that comes first after the start address ADD. Based on the calculated burst offset value OFF1, the bus cycle generation unit 26 judges whether an “undefined-length burst write” is necessary or not (Step S5).

If the burst offset value OFF1 is zero, namely, if the start address ADD matches a burst address boundary (Step S5; Yes), an undefined-length burst write is not performed. In this case, the bus cycle generation unit 26 performs a fixed-length burst write.

More specifically, the bus cycle generation unit 26 sets a burst transfer size to a size corresponding to the burst size BL (Step S10). Then, the bus cycle generation unit 26 reads data from the buffer 25 sequentially (Step S11), and writes the read data to the destination address ADD in the memory 3 (Step S12). Each time the bus cycle generation unit 26 writes one data, the bus cycle generation unit 26 changes the destination address (access address) ADD and reduces the burst transfer size and the transfer size TS by the amount of written data (Step S13). The above-mentioned Steps S11 to S13 are repeated until the burst transfer size becomes zero. When the burst transfer size becomes zero (Step S14; Yes), one fixed-length burst write is completed. After that, the processing proceeds to Step S100.

On the other hand, if the burst offset value OFF1 is not zero, namely, if the start address ADD does not match a burst address boundary (Step S5; No), an undefined-length burst write is performed.

More specifically, the bus cycle generation unit 26 sets a burst transfer size to the burst offset value OFF1 (Step S20). Then, the bus cycle generation unit 26 reads data from the buffer 25 sequentially (Step S21), and writes the read data to the destination address ADD in the memory 3 (Step S22). Each time the bus cycle generation unit 26 writes one data, the bus cycle generation unit 26 changes the destination address (access address) ADD and reduces the burst transfer size and the transfer size TS by the amount of written data (Step S23). The above-mentioned Steps S21 to S23 are repeated until the burst transfer size becomes zero. When the burst transfer size becomes zero (Step S24; Yes), the undefined-length burst write is completed. After that, the processing proceeds to Step S100.

In Step S100, if the transfer size TS is not zero (Step S100; No), the processing returns back to the above-mentioned Step S10. That is, the fixed-length burst write is performed subsequently. In other words, when the undefined-length burst write is performed once, only the fixed-length burst write is repeatedly performed thereafter. The bus cycle generation unit 26 performs the fixed-length burst write until writing of the whole transfer data DAT is completed.

When the DMA transfer of the whole transfer data DAT is completed (Step S100; Yes), the bus cycle generation unit 26 outputs the transfer completion signal SE to the DMA transfer controller 27.

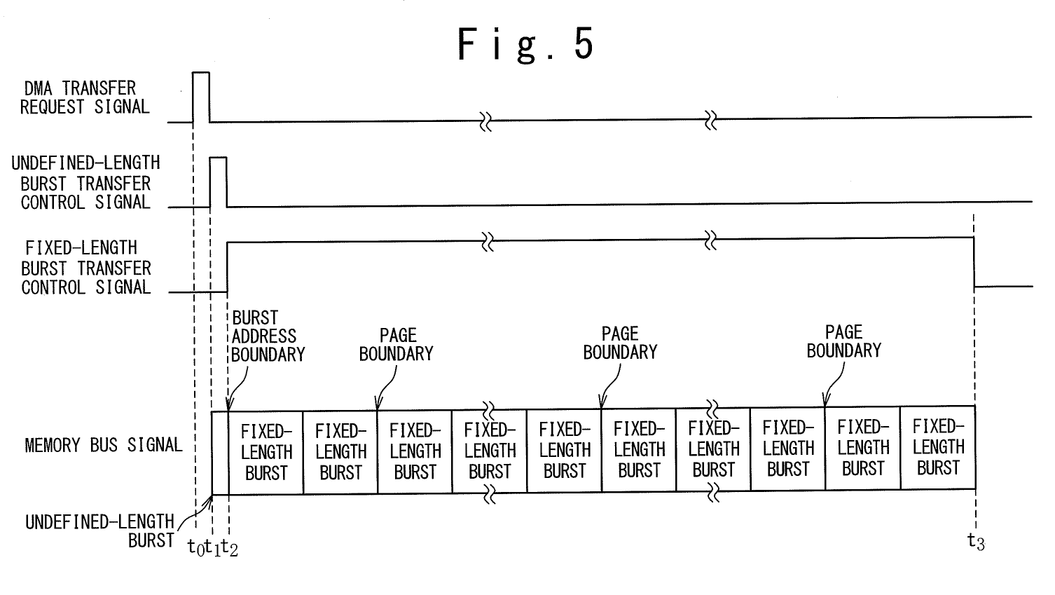

FIG. 5 is a timing chart showing one example of the DMA transfer. In the present example, one word is 32 bits and the data bus width is 4 bytes. The burst size BL is 4 and data of four words (16 bytes) is transferred in one fixed-length burst transfer. The page size of one page in the memory 3 is 512 words. As shown in FIG. 5, one page includes a plurality of burst address boundaries, and a page boundary matches one of the burst address boundaries.

At time t0, a DMA transfer request signal is input to the DMA transfer control device 2. In the present example, the destination address ADD (start address) that is initially set in the destination address register 21 is an address “0x0000000C”. In this case, a burst address boundary that appears first after the start address ADD exists between an address “0x0000000F” and an address “0x00000010.”Therefore, the burst offset value OFF1 is “4 bytes” equal to a size from the start address ADD to the burst address boundary.

Since the burst offset value OFF1 is not zero, i.e., the start address ADD does not match the burst address boundary (Step S5; No), an undefined-length burst write is performed. More specifically, at time t1, an undefined-length burst transfer control signal input to the bus cycle generation unit 26 is activated. The bus cycle generation unit 26 sets the burst transfer size to 4 bytes that is the burst offset value OFF1 (Step S20). Then, the bus cycle generation unit 26 performs an undefined-length burst transfer for 4 bytes from the address “0x0000000C” to the address ”0x0000000F” (Steps S21 to S24). That is to say, the bus cycle generation unit 26 performs the undefined-length burst transfer from the start address ADD to the burst address boundary. As a result, the destination address ADD (access address) reaches the burst address boundary.

After the undefined-length burst transfer is completed, a fixed-length burst transfer is performed subsequently. At time t2, the undefined-length burst transfer control signal is deactivated, and a fixed-length burst transfer control signal is activated instead. The bus cycle generation unit 26 sets the burst transfer size to 16 bytes that corresponds to the burst size BL (Step S10). Then, the bus cycle generation unit 26 performs a fixed-length burst transfer for 16 bytes from the address “0x00000010” to an address “0x0000001F” (Steps S11 to S14). That is, the bus cycle generation unit 26 performs the fixed-length burst transfer for one burst size from the current destination address ADD (current access address). As a result, the destination address ADD (access address) reaches the next burst address boundary.

After that, a fixed-length burst transfer is performed repeatedly. Each time the fixed-length burst transfer is performed, the destination address ADD (access address) reaches a burst address boundary. A page boundary that appears first exists between an address “0x000007FF” and an address “0x00000800.” As shown in FIG. 5, the page boundary matches a burst address boundary. Therefore, special processing such as interrupting the burst transfer operation is not necessary at the page boundary. Thereafter, the fixed-length burst transfer is further performed in a similar way regardless of page boundaries. The fixed-length burst transfer is repeated until the whole transfer data DAT are transferred, and the DMA transfer is completed at time t3.

As described above, the burst address boundaries in a page of the memory 3 are boundaries obtained by sectioning the page by the fixed-length burst size BL from the last address of the page (i.e. a page boundary of the page) towards the smaller address direction. Therefore, when an undefined-length burst transfer is first performed to adjust the access address to a burst address boundary, a first page boundary matches a certain burst address boundary during the subsequent fixed-length burst transfers. Also, the burst size BL is set to be an aliquot of the size of the page. Therefore, the subsequent page boundaries also match burst address boundaries, respectively, when all the subsequent transfers are fixed-length burst transfers.

### 1-3. Effects

According to the present embodiment, the undefined-length burst transfer is first performed for the burst offset value OFF1 from the access start address. After that, the fixed-length burst transfer is performed repeatedly until the transfer of the whole transfer data DAT is completed. That is to say, the undefined-length burst transfer is first performed from the access start address to a burst address boundary, and the fixed-length burst transfer is repeated after the access address reaches the burst address boundary.

Since a page boundary matches a burst address boundary, special processing such as interrupting a burst transfer operation is not necessary at the page boundary. The undefined-length burst transfer that is accompanied by the overheads needs not be performed at every page boundary. It is possible to repeat the fixed-length burst transfer until the whole transfer data DAT is transferred, without paying attention to the page boundaries. Therefore, the overheads at every page boundary are eliminated and thereby the deterioration of the data transfer efficiency can be prevented. In a case where large volume data need to be transferred (e.g. streaming transfer in the network communication) and thereby a large number of page boundary crossings occur during the data transfer, the effect becomes particularly remarkable.

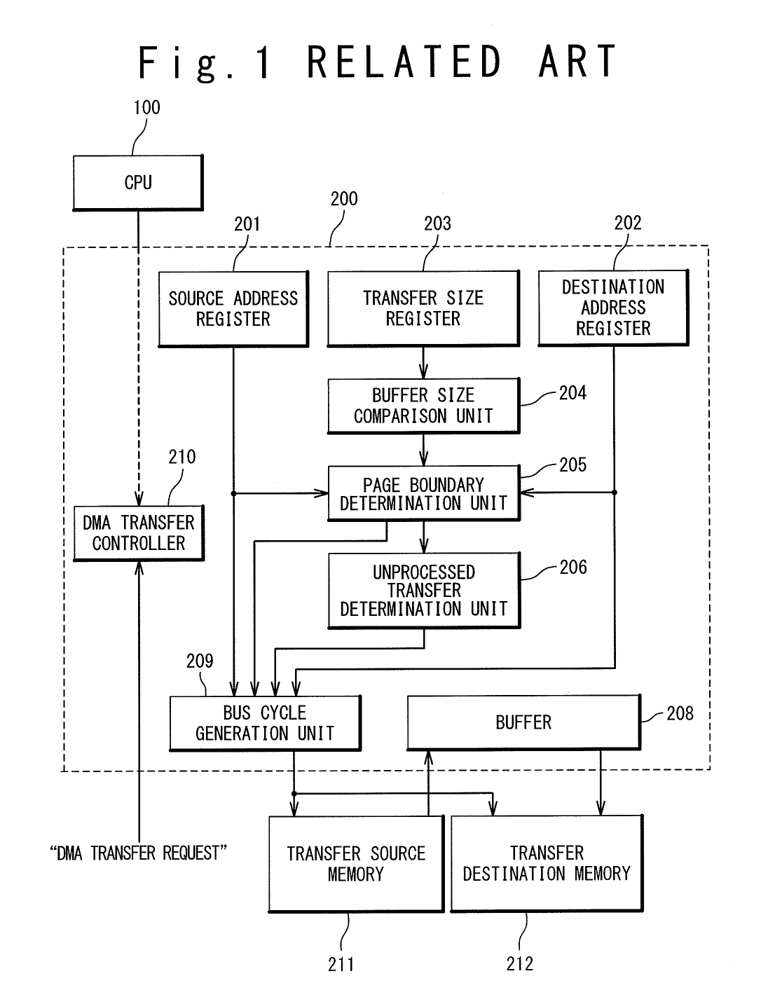

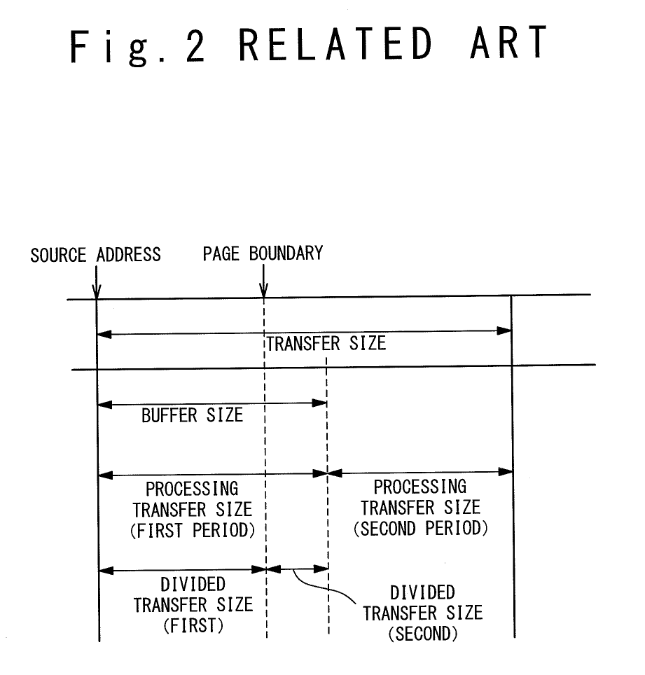

As an example, let us consider a case where a time required for the fixed-length burst transfer is T1 and a time required for the undefined-length burst transfer is T2 (>T1). According to the related technique shown in FIG. 1 and FIG. 2, the undefined-length burst transfer occurs two times across every page boundary. According to the present embodiment, on the other hand, the undefined-length burst transfer is performed only once at the start of the DMA transfer, and thereafter the fixed-length burst transfer is repeated. Therefore, a total time T required for the DMA transfer can be expressed as follows.

T (related technique)=T1×(number of transfer times−number of pages)+(T2×2)×number of pages;

T (present embodiment)=T2+T1×number of transfer times;

Number of transfer times=transfer size TS/(burst size BL×word length); and

Number of pages=transfer size TS/page size.

In the case of the related technique, it is clear that the total time T is increased as the number of pages becomes larger. In other words, the data transfer efficiency is decreased as the transfer size TS is increased. On the other hand, according to the present embodiment, the total time T does not depend on the number of pages. Therefore, the data transfer efficiency is not deteriorated even if the transfer size TS is increased.

Moreover, according to the present embodiment, it is not necessary to provide the buffer size comparison unit 204, the page boundary determination unit 205 and the unprocessed transfer determination unit 206 shown in FIG. 1. Instead, the burst address boundary determination circuit 24 is provided. The burst address boundary determination circuit 24 can be realized, for example, by a comparator that compares lower bits of the destination address ADD with the burst address boundary. Therefore, a circuit size can be reduced as compared with the configuration shown in FIG. 1.

In the above description, the case of data writing to the memory 3 has been explained. It should be noted that the same applies to a case of data reading from the memory 3. That is to say, the same applies to a case where the memory 3 serves as a “transfer source”. Moreover, the target is not limited to the memory 3 such as the SDRAM. The same applies to a case of peripheral such as an AMBA bus, a PCI bus and the like that has restriction of address boundary.

In the above-described example, the burst size BL is set to be an aliquot of the page size. Even in a case where the burst size BL is not an aliquot of the page size, the above-mentioned effects can be obtained to some extent. Also in this case, burst address boundaries in a page of the memory 3 are a plurality of boundaries obtained by sectioning the page by the fixed-length burst size BL from the last address of the page (i.e. a page boundary of the page) towards the smaller address direction. As in the case of the above-described example, the undefined-length burst transfer is performed from the start address to a burst address boundary, and the fixed-length burst transfer is repeated after the access address reaches the burst address boundary. When the access address reaches a page boundary of the first page including the start address, the data transfer moves to the next page. At the beginning of the next page, the start address is reset to the initial address of the next page. Then, another undefined-length burst transfer is performed such that the access address reaches a burst address boundary. After the access address reaches the burst address boundary, the fixed-length burst transfer is repeated in a similar manner. In this case, the undefined-length burst transfer occurs only once at every page boundary. Therefore, the number of undefined-length burst transfer that occurs across the page boundary is reduced as compared with the related technique shown in FIG. 1 and FIG. 2. As a result, the data transfer efficiency can be improved and also the circuit size can be reduced.

### 2. Second Embodiment

### 2-1. Configuration

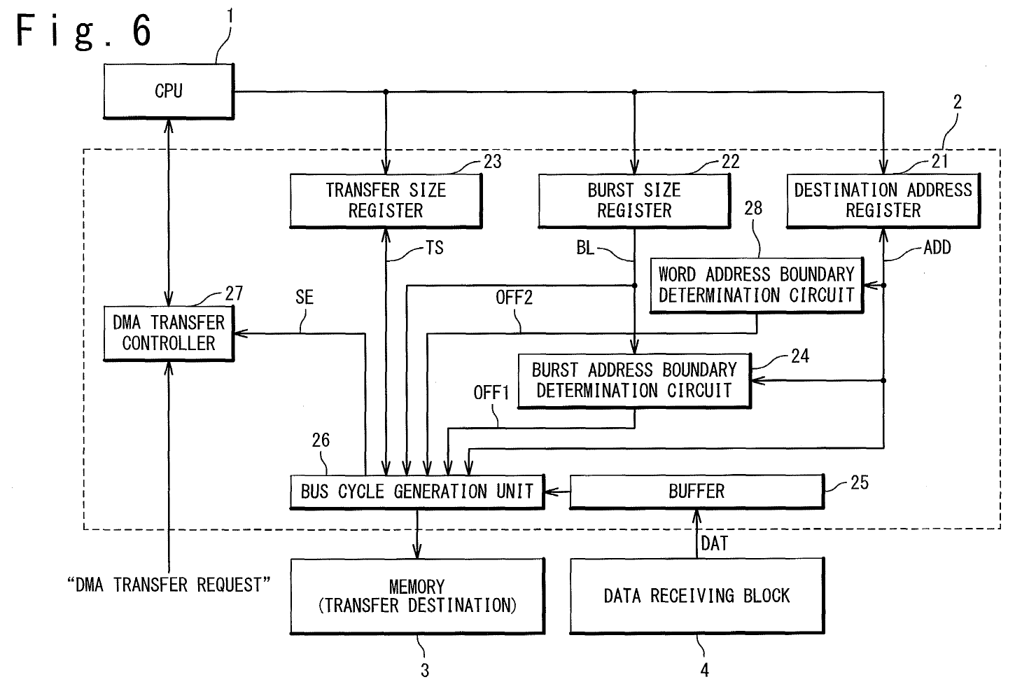

FIG. 6 is a block diagram showing a configuration of a data processing equipment according to a second embodiment of the present invention. In FIG. 6, the same reference numerals are given to the same components as those described in the first embodiment, and an overlapping description will be omitted as appropriate. The DMA transfer control device 2 according to the second embodiment includes a word address boundary determination circuit 28 in addition to the configuration shown in FIG. 3.

The word address boundary determination circuit 28 reads the destination address ADD from the destination address register 21. Based on the destination address ADD and the data bus width, the word address boundary determination circuit 28 calculates a “word offset value OFF2” that is an offset from the destination address ADD to a word address boundary that comes first after the destination address ADD. Here, the word address boundary means a boundary between two adjacent one-word memory areas. The word address boundary determination circuit 28 functions as an “offset calculation circuit” that calculates the word offset value OFF2. The calculated word offset value OFF2 is output to the bus cycle generation unit 26.

According to the present embodiment, the bus cycle generation unit 26 first performs a “byte transfer (byte write or byte read)” for the word offset value OFF2 from the destination address ADD (start address). If the word offset value OFF2 is equal to zero, the byte transfer is not performed. Subsequently, the bus cycle generation unit 26 performs an undefined-length burst transfer for the burst offset value OFF1 from the destination address ADD (access address). If the burst offset value OFF1 is equal to zero, the undefined-length burst transfer is not performed. After that, the bus cycle generation unit 26 performs the fixed-length burst transfer until the whole transfer data DAT is transferred.

### 2-2. Operation

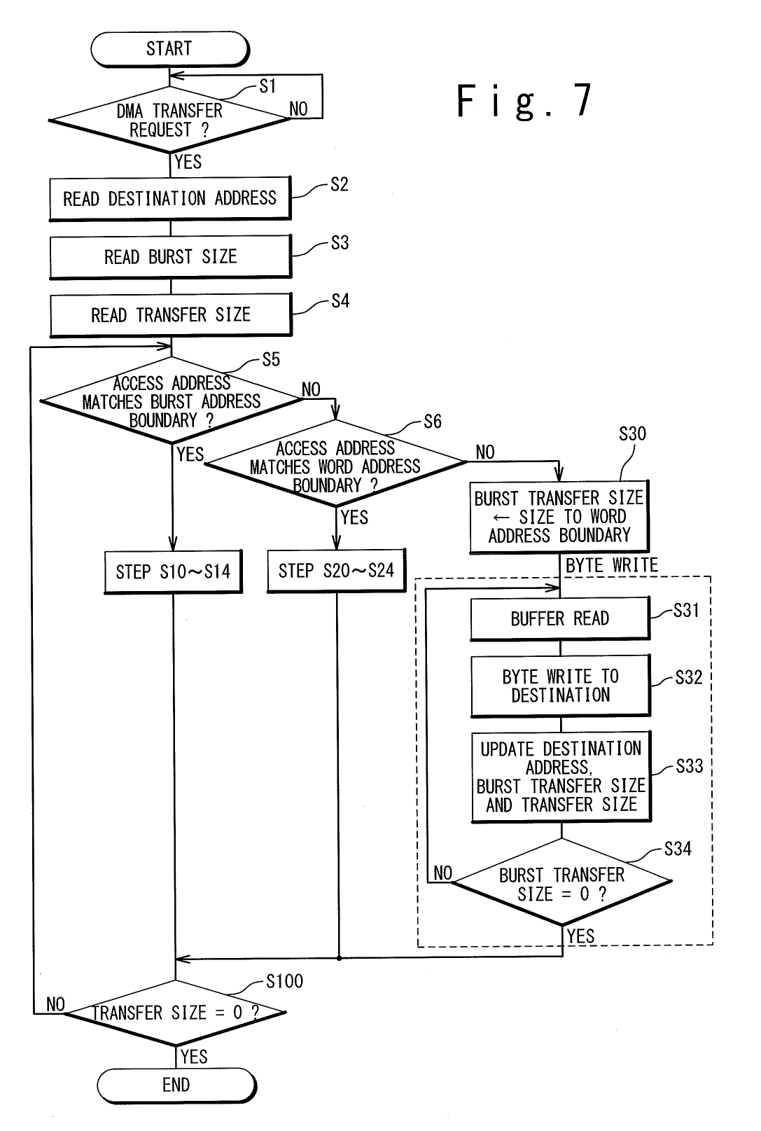

FIG. 7 is a flowchart showing an operation of the DMA transfer control device 2 according to the present embodiment. The description overlapping with the first embodiment will be omitted as appropriate.

The burst address boundary determination circuit 24 calculates the burst offset value OFF1 based on the destination address ADD and the burst size BL. Moreover, the word address boundary determination circuit 28 calculates the word offset value OFF2 based on the destination address ADD and the data bus width. Based on the calculated burst offset value OFF1, the bus cycle generation unit 26 judges whether an “undefined-length burst write” is necessary or not (Step S5). Moreover, based on the calculated word offset value OFF2, the bus cycle generation unit 26 judges whether a “byte write” is necessary or not (Step S6).

If the word offset value OFF2 is not zero, namely, if the destination address (start address) ADD does not match a word address boundary (Step S5; No, Step S6; No), a “byte write” is performed.

More specifically, the bus cycle generation unit 26 sets a burst transfer size to the word offset value OFF2 (Step S30). Then, the bus cycle generation unit 26 reads one-byte data from the buffer 25 (Step S31), and writes the one-byte data to the destination address ADD in the memory 3 (Step S32). Each time the bus cycle generation unit 26 writes one data, the bus cycle generation unit 26 changes the destination address (access address) ADD and reduces the burst transfer size and the transfer size TS by the amount of written data (Step S33). The above-mentioned Steps S31 to S33 are repeated until the burst transfer size becomes zero. When the burst transfer size becomes zero (Step S34; Yes), the byte write is completed. After that, the processing proceeds to Step S100.

In Step S100, if the transfer size TS is not zero (Step S100; No), the processing returns back to the above-mentioned Step S5. The burst address boundary determination circuit 24 calculates the burst offset value OFF1 again, based on the destination address (access address) ADD after update and the burst size BL.

If the destination address ADD (access address) matches a word address boundary (Step S6; Yes), the bus cycle generation unit 26 performs the undefined-length burst write as described above (Steps S20 to S24). If the destination address ADD (access address) matches a burst address boundary (Step S5; Yes), the bus cycle generation unit 26 performs the fixed-length burst write as described above (Steps S10 to S14).

When the DMA transfer of the whole transfer data DAT is completed (Step S100; Yes), the bus cycle generation unit 26 outputs the transfer completion signal SE to the DMA transfer controller 27.

As an example, let us consider a case similar to that in the first embodiment where one word is 32 bits and the data bus width is 4 bytes. The burst size BL is 4 and data of four words (16 bytes) is transferred in one fixed-length burst transfer. The page size of one page in the memory 3 is 512 words.

The destination address ADD (start address) that is initially set in the destination address register 21 is an address “0x0000000A”. In this case, a word address boundary that appears first after the start address ADD exists between an address “0x0000000B” and an address “0x00000000C”. Therefore, the word offset value OFF2 is “2 bytes” equal to a size from the start address ADD to the word address boundary. The bus cycle generation unit 26 performs a byte write for 2 bytes from the address “0x0000000A” to the address “0x0000000B” (Steps S30 to S34). That is to say, the bus cycle generation unit 26 performs the byte write from the start address ADD to the word address boundary. As a result, the destination address ADD (access address) reaches the word address boundary.

As a result of the byte write, the destination address ADD (access address) has become the address “0x0000000C”. Then, as in the case of FIG. 5, the bus cycle generation unit 26 performs the undefined-length burst transfer for 4 bytes from the address “0x0000000C” to the address “0x0000000F” (Steps S20 to S24). Following the undefined-length burst transfer, the fixed-length burst transfer is performed (Steps S10 to S14). The fixed-length burst transfer is repeated until the whole transfer data DAT is transferred, regardless of the page boundary.

### 2-3. Effects

According to the present embodiment, the same effects as in the first embodiment can be obtained. The effects can be obtained even when the start address does not match a word address boundary. In the above description, the case of data writing to the memory 3 has been explained. It should be noted that the same applies to a case of data reading from the memory 3.

### 3. Third Embodiment

### 3-1. Configuration

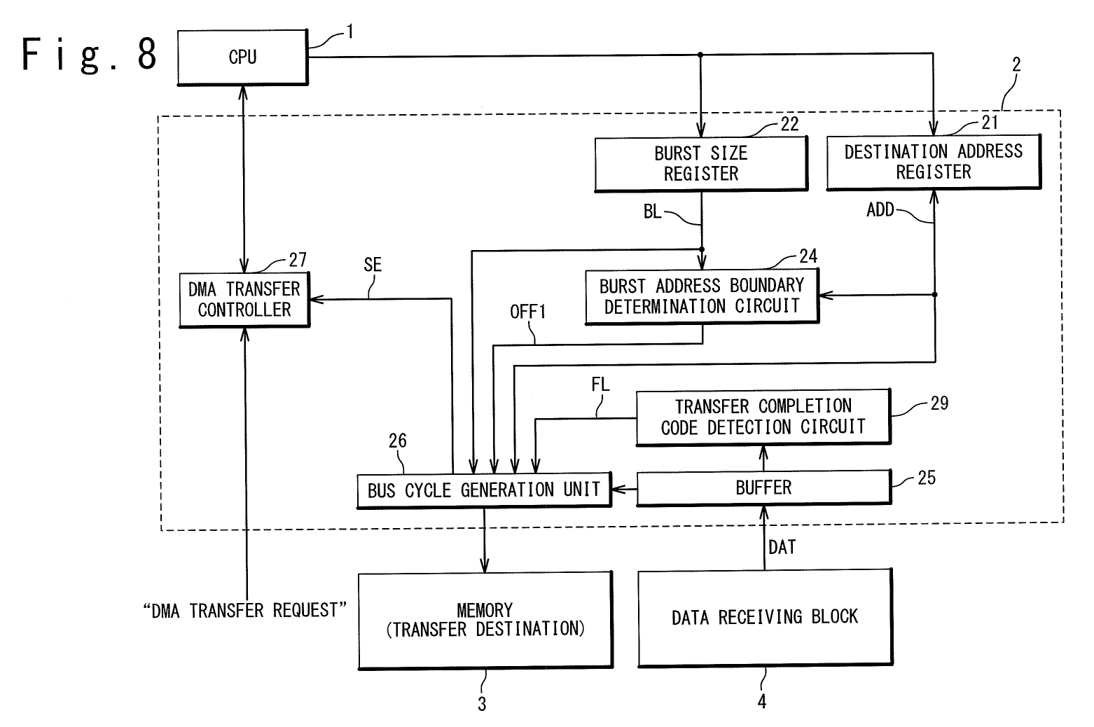

FIG. 8 is a block diagram showing a configuration of a data processing equipment according to a third embodiment of the present invention. In FIG. 8, the same reference numerals are given to the same components as those described in the first embodiment, and an overlapping description will be omitted as appropriate. The DMA transfer control device 2 according to the third embodiment includes a transfer completion code detection circuit 29 in addition to the configuration shown in FIG. 3. Moreover, the transfer size register 23 is eliminated from the DMA transfer control device 2.

The transfer completion code detection circuit 29 detects a specific transfer completion code from the transfer data DAT stored in the buffer 25. The transfer completion code indicates transfer completion of the transfer data DAT. For example, the transfer completion code is calculated from data sequence in the transfer data DAT, and only one kind exists. When detecting the transfer completion code, the transfer completion code detection circuit 29 outputs a completion code flag signal FL to the bus cycle generation unit 26.

When the bus cycle generation unit 26 receives the completion code flag signal FL, the bus cycle generation unit 26 turns ON a completion code flag. The bus cycle generation unit 26 detects the completion of the DMA transfer by referring to the completion code flag, instead of comparing the amount of transfer data DAT written to the memory 3 with the transfer size TS. When the DMA transfer of the whole transfer data DAT is completed, the bus cycle generation unit 26 outputs the transfer completion signal SE to the DMA transfer controller 27.

### 3-2. Operation

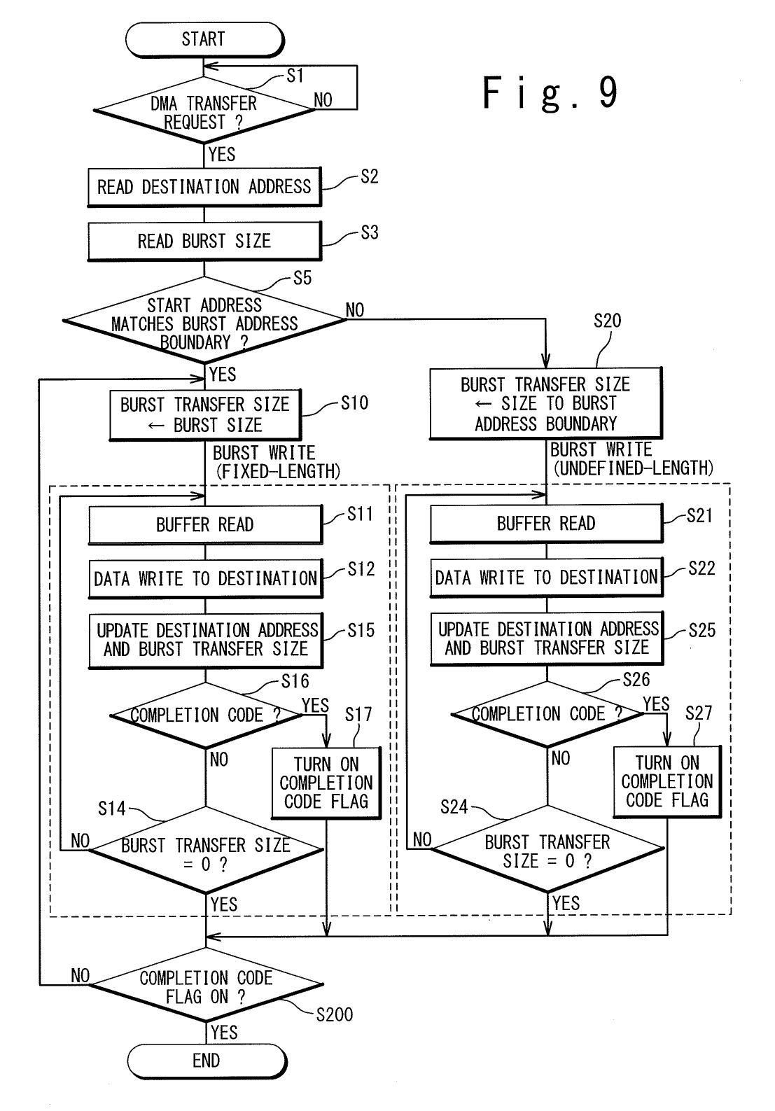

FIG. 9 is a flowchart showing an operation of the DMA transfer control device 2 according to the present embodiment. The description overlapping with the first embodiment will be omitted as appropriate. In the present embodiment, the reading of the transfer size TS (Step S4) is not performed.

During the fixed-length burst write, the bus cycle generation unit 26 sets a burst transfer size to a size corresponding to the burst size BL (Step S10). Then, the bus cycle generation unit 26 reads data from the buffer 25 sequentially (Step S11), and writes the read data to the destination address ADD in the memory 3 (Step S12). Each time the bus cycle generation unit 26 writes one data, the bus cycle generation unit 26 changes the destination address (access address) ADD and reduces the burst transfer size by the amount of written data (Step S15).

The transfer completion code detection circuit 29 performs detection of the transfer completion code. If the transfer completion code is detected (Step S16; Yes), the transfer completion code detection circuit 29 outputs the completion code flag signal FL to the bus cycle generation unit 26. In response to the completion code flag signal FL, the bus cycle generation unit 26 turns ON the completion code flag (Step S17). After that, the processing proceeds to Step S200. If the transfer completion code is not detected (Step S16; No), the above-mentioned Steps S11 to S16 are repeated until the burst transfer size becomes zero. When the burst transfer size becomes zero (Step S14; Yes), one fixed-length burst write is completed. After that, the processing proceeds to Step S200.

During the undefined-length burst write, the bus cycle generation unit 26 sets a burst transfer size to the burst offset value OFF1 (Step S20). Then, the bus cycle generation unit 26 reads data from the buffer 25 sequentially (Step S21), and writes the read data to the destination address ADD in the memory 3 (Step S22). Each time the bus cycle generation unit 26 writes one data, the bus cycle generation unit 26 changes the destination address (access address) ADD and reduces the burst transfer size by the amount of written data (Step S25).

The transfer completion code detection circuit 29 performs detection of the transfer completion code. If the transfer completion code is detected (Step S26; Yes), the transfer completion code detection circuit 29 outputs the completion code flag signal FL to the bus cycle generation unit 26. In response to the completion code flag signal FL, the bus cycle generation unit 26 turns ON the completion code flag (Step S27). After that, the processing proceeds to Step S200. If the transfer completion code is not detected (Step S26; No), the above-mentioned Steps S21 to S26 are repeated until the burst transfer size becomes zero. When the burst transfer size becomes zero (Step S24; Yes), the undefined-length burst write is completed. After that, the processing proceeds to Step S200.

In Step S200, if the completion code flag indicates OFF (Step S200; No), the processing returns back to the above-mentioned Step S10. That is, the fixed-length burst write is performed subsequently. On the other hand, if the completion code flag indicates ON (Step S200; Yes), the bus cycle generation unit 26 outputs the transfer completion signal SE to the DMA transfer controller 27.

### 3-3. Effects

According to the present embodiment, the same effects as in the first embodiment can be obtained. In the above description, the case of data writing to the memory 3 has been explained. It should be noted that the same applies to a case of data reading from the memory 3. Moreover, it is also possible to apply the transfer completion code detection circuit 29 to the above-described second embodiment.

It is apparent that the present invention is not limited to the above embodiments and may be modified and changed without departing from the scope and spirit of the invention.

What is claimed is:

1. A DMA transfer control device for controlling a DMA transfer between a source and a destination, comprising:
a buffer in which a transfer data is stored; and
a bus cycle generation unit configured to perform a burst transfer of said transfer data between said buffer and said source or said destination,
wherein said bus cycle generation unit performs an undefined-length burst transfer until an access address reaches a burst address boundary in said source or said destination, and
wherein said bus cycle generation unit performs a fixed-length burst transfer after said undefined-length burst transfer until transfer of said transfer data is completed.

2. The DMA transfer control device according to claim 1,
wherein said bus cycle generation unit performs said undefined-length burst transfer from an access start address to said burst address boundary in said source or said destination.

3. The DMA transfer control device according to claim 2, further comprising an offset calculation circuit configured to calculate an offset value from said access start address to said burst address boundary based on a burst length and said access start address,
wherein said bus cycle generation unit performs said undefined-length burst transfer for data of said offset value from said access start address.

4. The DMA transfer control device according to claim 1,
wherein said bus cycle generation unit performs a byte transfer from an access start address to a word address boundary in said source or said destination, and
wherein said bus cycle generation unit performs said undefined-length burst transfer from said word address boundary to said burst address boundary after said byte transfer.

5. The DMA transfer control device according to claim 4, further comprising:
a first offset calculation circuit configured to calculate a first offset value from said access start address to said word address boundary based on a data bus width and said access start address; and
a second offset calculation circuit configured to calculate a second offset value from a current access address to said burst address boundary based on a burst length and said current access address,
wherein said bus cycle generation unit performs said byte transfer for data of said first offset value from said access start address and then performs said undefined-length burst transfer for data of said second offset value.

6. The DMA transfer control device according to claim 1,
wherein said bus cycle generation unit detects completion of said DMA transfer by comparing a data amount transferred to said destination with a size of said transfer data.

7. The DMA transfer control device according to claim 1, further comprising a completion code detection circuit configured to detect a completion code from said transfer data, wherein said completion code indicates transfer completion of said transfer data,
wherein said bus cycle generation unit stops said DMA transfer when said completion code is detected.

8. A method of DMA transfer of a transfer data between a source and a destination, comprising:
performing an undefined-length burst transfer of said transfer data until an access address reaches a burst address boundary in said source or said destination; and
performing a fixed-length burst transfer of said transfer data after said undefined-length burst transfer until transfer of said transfer data is completed.
